(19) United States
(12) Patent Application Publication
(10) Pub. No.: US 2020/0153142 A1
(43) Pub. Date: May 14, 2020

(54) SPRING CONTACT ON A RECHARGEABLE BATTERY

(71) Applicant: Hilti Aktiengesellschaft, Schaan (DE)

(72) Inventors: Ralf Meixner, Germaringen (DE); Johannes Stempfhuber, Utting am Ammersee (DE)

(21) Appl. No.: 16/606,512

(22) PCT Filed: Apr. 16, 2018
(86) PCT No.: PCT/EP2018/059656

§ 371 Date: Dec. 3, 2019

(30) Foreign Application Priority Data
Apr. 21, 2017 (EP) 17167447.6

(51) Int. Cl. H01R 13/15; H01R 13/11; B25F 5/02

(52) U.S. Cl. CPC H01R 13/15; H01R 24/68; B25F 5/02; H01R 13/112

(57) ABSTRACT

A power tool, which includes a receiving device having at least one receiving element and a power supply unit connectable to the power tool, for example a rechargeable battery, which includes a connecting device, the connecting device having at least one contact element, the receiving device being designed to receive and hold the connecting device, so that the at least one receiving element and the at least one contact element are connectable to each other for establishing an electrical connection. A damping element is provided on at least one contact element, whereby the at least one contact element is movable in a first direction and a second direction as well as relative to the particular receiving element, so that it is possible to counteract a relative movement between the contact element and the particular receiving element when the contact element and the receiving element are connected to each other.

The present invention relates to a power tool, which includes a receiving device having at least one receiving element and a power supply unit connectable to the power tool, for example a rechargeable battery, which includes a connecting device, the connecting device having at least one contact element, the receiving device being designed to receive and hold the connecting device, so that the at least one receiving element and the at least one contact element are connectable to each other for establishing an electrical connection.

### BACKGROUND

Cordless power tools may be operated with the aid of a rechargeable battery for power supply purposes. The rechargeable battery may be removed from the power tool to be able to recharge it with electrical current in a charging device.

In an assembled state, i.e. when the power tool and the rechargeable battery are connected to each other, the transmission of the electrical current from the rechargeable battery to the power tool takes place with the aid of electrical contact partners. The contact partners are each made up of a first and a second contact element, which are connectable to each other. The first electrical contact element is situated on the rechargeable battery, and the second contact element is situated on the power tool. The second contact element is usually inserted into the first contact element. The second contact element may also be referred to as a receiving element, since it is suitable, among other things, for receiving the electrical current for the power tool.

During the operation of the power tool, a high mechanical load in the form of acceleration forces may act upon the electrical contact elements, due to application-induced vibrations or oscillations. In addition to this mechanical load, an electrical load in the form of electrical current may also take effect.

This mechanical load may result in relative movements between the contact elements on the power tool and battery sides, which cause wear on the contact elements. Depending on the application of the power tool, this wear may be additionally amplified by an introduction of dust between the contact elements. Due to the vibration-induced relative movement between the contact elements as well as due to a wear-induced increase in the contact resistance of the contact elements, a thermal overload of the contact elements may occur, which may even result in a burn-off of the contact elements.

### BACKGROUND

It is an object of the present invention to provide a power tool having improved contact elements, in which a wear and, in particular the risk of a burn-off of the contact elements, is reduced.

The present invention provides a power tool, which includes a receiving device having at least one receiving element and a power supply unit connectable to the power tool, for example a rechargeable battery, which includes a connecting device, the connecting device having at least one contact element, the receiving device being designed to receive and hold the connecting device, so that the at least one receiving element and the at least one contact element are connectable to each other for establishing an electrical connection.

A damping element is provided on at least one contact element, whereby the at least one contact element is movable in a first direction and a second direction as well as relative to the particular receiving element, so that it is possible to counteract a relative movement between the contact element and the particular receiving element when the contact element and the receiving element are connected to each other.

A relative movement between the contact element and the receiving element may be reduced hereby, thus making it possible to counteract the vibration-induced wear on the contact element and the receiving element.

According to one advantageous specific embodiment of the present invention, it may be provided that the damping element is designed as a spring and is positioned behind the contact element in the first direction, so that a spring force applied by the damping element designed as a spring presses the contact element in the second direction. In particular, the maximum freedom of movement of the contact element relative to the receiving element may be effectively counteracted hereby.

According to an alternative specific embodiment, however, it is also possible for the damping element to be designed as a component including an elastically deformable material. An elastomer or any other suitable dimensionally stable yet elastically deformable plastic is possible as the material.

This makes it possible to easily counteract a vibration-induced movement of the contact element in multiple directions, i.e. not only in the direction of or against the direction of the receiving element.

### BRIEF DESCRIPTION OF THE DRAWINGS

Other advantages result from the following description of the figures. The figures illustrate different exemplary embodiments of the present invention. The figures, the description and the claims contain numerous features in combination. Those skilled in the art will advantageously also consider the features individually and combine them to form other meaningful combinations.

FIG. 1 shows a side view of a power tool according to the present invention, including a rechargeable battery connected to the power tool;

FIG. 2 shows another side view of a power tool according to the present invention, including a rechargeable battery removed from the power tool;

FIG. 3 shows a sectional view along section line A-A in FIG. 1, the rechargeable battery and the power tool being separated from each other; and

FIG. 4 shows a sectional view along section line B-B in FIG. 2, the rechargeable battery and the power tool being connected to each other.

### DETAILED DESCRIPTION

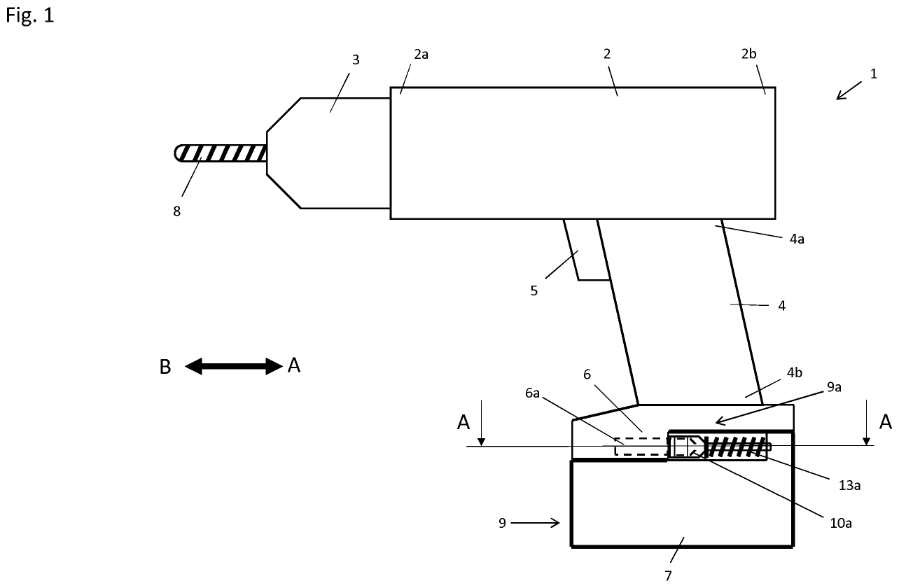

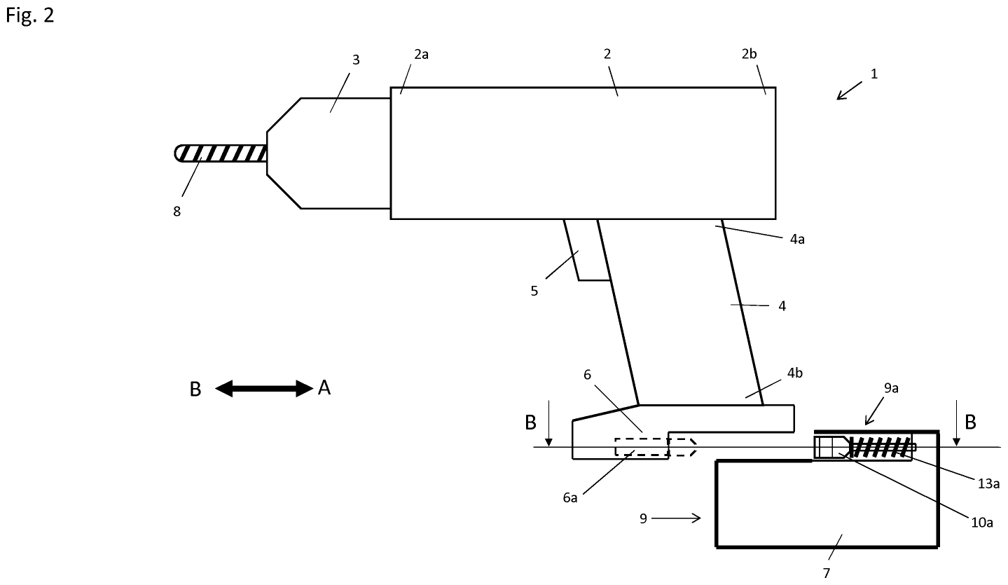

An example of a specific embodiment of power tool 1 according to the present invention is illustrated in FIGS. 1 and 2.

Power tool 1 is designed in the form of a power drill. However, it is also possible for power tool 1 to be a hammer drill, a circular saw or the like.

Power tool 1 illustrated in FIGS. 1 and 2 essentially includes a housing 2, a tool holder 3 and a handle 4, which has an activation switch 5. In addition, power tool 1 includes a receiving device 6 for a power supply unit 7. As illustrated in FIGS. 1 through 4, power supply unit 7 is designed as a rechargeable battery, also referred to as a battery.

According to another specific embodiment of the present invention (not illustrated in the figures), power supply unit 7 may also be designed as a connecting unit having a power cord for connection to a power network.

FIG. 1 shows a state in which power supply unit 7 designed as a battery is connected to power tool 1. For this purpose, battery 7 is pushed onto receiving device 6 in arrow direction B. As illustrated in FIG. 2, battery 7 may be removed again from receiving device 6, and thus from power tool 1, according to arrow direction A (and against arrow direction B). Power supply unit 7 is held on power tool 1 by a locking device, which is not illustrated.

Housing 2 has a first end 2a and a second end 2b. Tool holder 3 is positioned on a first end 2a of housing 2. Tool holder 3 is used to receive and detachably hold a tool 8. Tool 8 illustrated in FIGS. 1 and 2 is designed in the form of a drill.

Handle 4 has activation switch 5, a first end 4a and a second end 4b. Activation switch 5 is used to actuate power tool 1. First end 4a of handle 4 is fastened to a second end 2b of the housing and below housing 2.

Receiving device 6 for power supply unit 7 designed as a battery is positioned on second end 4b of handle 4.

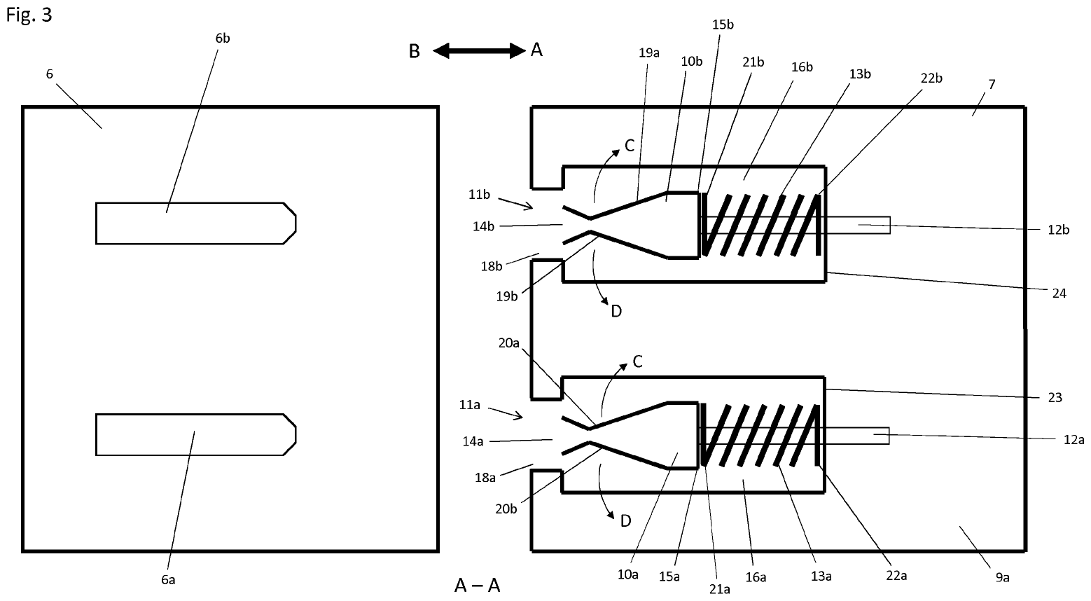

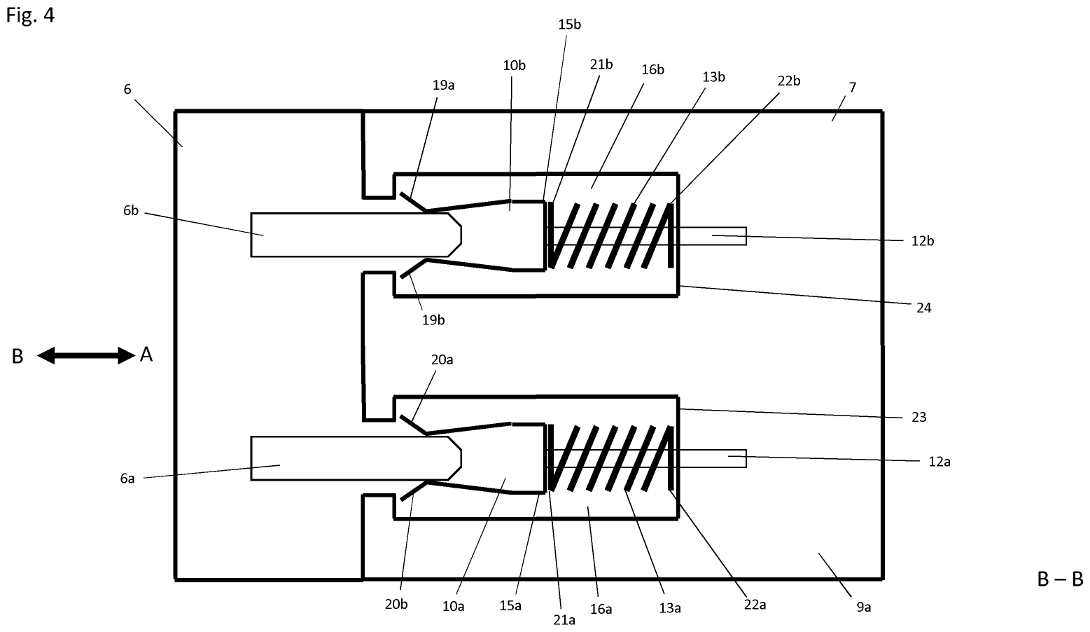

As illustrated in FIGS. 3 and 4, receiving device 6 includes a first receiving element 6a and a second receiving element 6b. Alternatively, more than two receiving elements may be provided. It is possible that one receiving element has both a positive pole and a negative pole for supplying electrical power. Both first and second receiving elements 6a, 6b are designed in the form of a contact plate. Alternatively, first and second receiving element 6a, 6b may also be designed as a cylinder.

Power supply unit 7 designed as a battery essentially includes a housing 9, in which a number of individual, interconnected power storage cells, also referred to as battery cells, are positioned. With the aid of the battery cells, electrical energy may be stored in battery 7.

The battery cells are not illustrated in the figures.

A connecting device 9a, which has a first contact element 10a and a second contact element 10b, is positioned on an upper end of housing 9. Connecting device 9a is used for connection to receiving device 6. For this purpose, connecting device 9a is inserted into receiving device 6 and held thereby.

Alternatively, more than two contact elements may also be provided. It is possible that one contact element has both a positive pole and a negative pole for supplying electrical power.

First contact element 10a is used for detachable connection to first receiving element 6a, and second contact element 10b is used for detachable connection to second receiving element 6b (cf. FIGS. 3 and 4). By connecting first and second contact elements 10a, 10b to particular first and second receiving elements 6a, 6b, the electrical energy stored in the battery cells may be conducted from battery 7 to receiving device 6. The electrical energy is subsequently passed on to electrical consumers in power tool 1.

In the specific embodiment which is not illustrated, in which power supply unit 7 is not designed as a battery but as a connecting unit for a power network, the connecting unit also has a first contact element 10a and a second contact element 10b for the particular connection and establishment of an electrical connection with first and second receiving elements 6a, 6b of receiving device 6.

An electric motor for generating a torque is positioned in housing 2 of power tool 1. The electric motor is thus an electrical consumer of electrical energy. The torque generated in the electric motor is transmitted to tool holder 3 via an output shaft and a transmission. Tool 8 is rotated with the aid of the transmitted torque. The electric motor, the output shaft and the transmission are not illustrated in the figures.

As illustrated, in particular in FIGS. 3 and 4, first contact element 10a includes a first contact plug 11a, a first litz wire 12a and a first damping element 13a. Second contact element 10b includes a second contact plug 11b, a second litz wire 12b and a second damping element 13b. First contact plug 10a has a first end 14a and a second end 15a. Second contact plug 11b has a first end 14b and a second end 15b. First litz wire 12a is connected to second end 15a of first contact plug 10a, and second litz wire 12b is connected to second end 15b of second contact plug 10b. Litz wires 12a, 12b are provided with a flexible design and permit a movement of contact plugs 11a, 11b in directions A and B. Moreover, litz wires 12a, 12b are used to transmit the electrical energy from the battery cells to particular contact elements 10a, 10b.

First contact element 10a is furthermore situated in a first contact chamber 16a, and second contact element 10b is situated in a second contact chamber 16b. The two contact chambers 16a, 16b are essentially designed as bulges for particular contact elements 10a, 10b and are positioned side by side on an upper end 17 of battery housing 9. Each contact chamber 16a, 16b designed as a bulge thus has an opening 18a, 18b, through which contact plugs 11a, 11b are accessible in contact chambers 16a, 16b. The two contact plugs 11a, 11b are situated in particular contact chambers 16a, 16b in such a way that first end 14a, 14b of particular contact plug 11a, 11b faces opening 18a, 18b of contact chamber 16a, 16b.

In addition, first contact plug 11a includes a first contact blade 19a and a second contact blade 19b, and second contact plug 11b includes a first contact blade 20a and a second contact blade 20b.

As indicated in FIG. 3, contact blades 19a, 19b, 20a, 20b are provided with a movable or flexible design, so that first contact blade 19a, 20a may be reversibly or elastically pivoted in arrow direction C, and second contact blade 19b, 20b may be reversibly or elastically pivoted in arrow direction D. The movability of contact blades 19a, 19b, 20a, 20b is used to be able to receive particular receiving element 6a, 6b designed as contact plates, so that each contact plate abuts first and second contact blades 19a, 19b, 20a, 20b when battery 7 is properly connected to power tool 1 (cf. FIG. 4).

First and second damping elements 13a, 13b are designed as springs according to the present exemplary embodiment. Spring 13a a first end 21a as well as a second end 22a, and spring 13b a first end 21b and a second end 22b. Each damping element 13a, 13b designed as a spring is situated in particular contact chamber 16a, 16b and in relation to particular contact plug 11a, 11b in such a way that first end 21a, 21b of spring 13a, 13b abuts second end 15a, 15b of particular contact plug 11a, 11b. Second end 22a, 22b of each spring 13a, 13b abuts a back wall 23, 24 of each contact chamber 16a, 16b. The spring force of each spring 13a, 13b thus presses particular contact plug 11a, 11b in arrow direction A. It should be noted that the length and characteristic of particular litz wires 12a, 12b are selected in such a way that they may follow the entire spring deflection of springs 13a, 13b. In other words, litz wires 12a, 12b are at least long enough that they are not torn off by particular contact plug 11a, 11b when contact plug 11a, 11b is moved over the entire distance in direction A.

With the aid of damping elements 13a, 13b designed as springs, vibration-induced relative movements (e.g. in arrow directions A and B) may be compensated for, which occur between contact element 10a, 10b and receiving element 6a, 6b when machine tool 1 is in use.

What is claimed is:

1-3. (canceled)

4. A power tool comprising:
a receiving device having at least one receiving element;
a power supply unit connectable to the power tool and including a connecting device, the connecting device having at least one contact element,
the receiving device being designed to receive and hold the connecting device, so that the at least one receiving element and the at least one contact element are connectable to each other to establish an electrical connection: and
a damping element on the at least one contact element, the at least one contact element being movable in a first direction and a second direction as well as relative to a respective receiving element of the at least one receiving element to be able to counteract a relative movement between the contact element and the respective receiving element when the contact element and the receiving element are connected to each other.

5. The power tool as recited in claim 4 wherein the damping element is designed as a spring and is positioned behind the contact element in the first direction, so that a spring force applied by the spring presses the contact element in the second direction.

6. The power tool as recited in claim 4 wherein the damping element is designed as a component including an elastically deformable material.

7. A power drill comprising the power tool as recited in claim 4.

8. The power tool as recited in claim 4 wherein the power supply unit is a rechargeable battery.
